(19) United States
(12) Patent Application Publication
(10) Pub. No.: US 2022/0114511 A1
(43) Pub. Date: Apr. 14, 2022

(54) TRANSPORT SERVICE SYSTEM AND TRANSPORT SERVICE PROVIDING METHOD

(71) Applicant: HITACHI, LTD., Tokyo (JP)

(72) Inventors: Tomoichi EBATA, Tokyo (JP); Kojin YANO, Tokyo (JP); Satoru HORI, Tokyo (JP); Kei SUZUKI, Tokyo (JP)

(73) Assignee: HITACHI, LTD., Tokyo (JP)

(21) Appl. No.: 17/431,980

(22) PCT Filed: Feb. 21, 2020
(86) PCT No.: PCT/JP2020/007262

§ 371 Date: Aug. 18, 2021

(30) Foreign Application Priority Data
Mar. 25, 2019 (JP) 2019-057161

(51) Int. Cl. G06Q 10/06; G06Q 30/02

(52) U.S. Cl. CPC G06Q 10/0631; G06Q 30/0282

(57) ABSTRACT

A transportation service improvement for a user by reflects the degree of dissatisfaction of the user on the operation of a vehicle. In a transport service system that provides a service of operating a transport resource to transport a user, a third management device acquires a numerical value representing dissatisfaction of the user, a first management device gives a point corresponding to the dissatisfaction and stores a point for each of users in a first database, the point being usable for executing a request for the operation of the transport resource, and the third management device receives a request from the user and changes a plan of the operation of the transport resource based on the request and the status of the operation of the transport resource that is managed by a second database in exchange for the point given to the user that is managed by the first database.

### TECHNICAL FIELD

The present invention relates to a technique of controlling the operation of a vehicle in a transportation service using the degree of dissatisfaction of a user.

### BACKGROUND ART

In general, in a public transportation service, a service provider determines the service content in advance and operates the service. That is, the service provider determines a vehicle operation schedule (diagram) in advance and causes vehicles to travel according to the schedule.

On the other hand, JP-A-2006-163738 (PTL 1) discloses a technique of mobilizing an extra vehicle when it is determined that a bus traveling a travel route according to a timetable does not arrive at a checkpoint at a predetermined time.

JP-A-2015-191364 (PTL 2) discloses a technique for allowing a ride-sharing with another user in a vehicle of a provider. Past record information of a transport path of the vehicle of the provider is accumulated, and a transport plan is made based on the record information. Next, a ride-sharing request is transmitted to the provider of the vehicle. If the provider accepts the request, the provider allows a user who requests ride-sharing to share the vehicle of the provider.

JP-A-2013-080272 (PTL 3) discloses a technique of reproducing and evaluating a traffic status based on a computer simulation using a virtual object that simulates a vehicle.

“Technical Study: Revision of Traffic Demand Forecast” Ministry of Land, Infrastructure, Transport, and Tourism, Japan (NPL 1) discloses a calculation formula and a parameter with which the traffic volume regarding the transport of persons (passenger vehicle) and the transport of objects (cargo vehicle) is forecasted to forecast the future traffic demand including trip generation rate, trip distribution, and traffic assignment.

### CITATION LIST

### Patent Literature

PTL 1: JP-A-2006-163738
PTL 2: JP-A-2015-191364
PTL 3: JP-A-2013-080272

### Non-Patent Literature

NPL 1: “Technical Study: Revision of Traffic Demand Forecast” Ministry of Land, Infrastructure, Transport, and Tourism, Japan (http://www.mlit.go.jp/tec/tec_mn_000003.html (Dec. 11, 2018))

### SUMMARY OF INVENTION

### Technical Problem

As described above, in a public transportation service in the related art, the dissatisfaction of a user cannot be quantitatively reflected on the operation of a vehicle.

One object of the present disclosure is to provide a technique capable of providing an improved transportation service to a user by reflecting the degree of dissatisfaction of the user on the operation of a vehicle.

### Solution to Problem

A transport service system according to one aspect of the present disclosure is a transport service system that provides a service of operating a transport resource to transport a user, the transport service system including: a first management device that stores a first database regarding the user and manages a request of the user; a second management device that stores a second database regarding the transport resource and manages a status of an operation of the transport resource; and a third management device that changes the operation of the transport resource in cooperation with the first management device and the second management device, in which the third management device acquires a numerical value representing dissatisfaction of the user, the first management device gives a point corresponding to the dissatisfaction and stores a point for each of users in the first database, the point being usable for executing a request for the operation of the transport resource, and the third management device receives a request from the user and changes a plan of the operation of the transport resource based on the request and the status of the operation of the transport resource that is managed by the second database in exchange for the point given to the user that is managed by the first database.

### Advantageous Effects of Invention

The present disclosure can improve a transportation service for a user by reflecting the degree of dissatisfaction of the user on the operation of a vehicle.

### BRIEF DESCRIPTION OF DRAWINGS

FIG. 1 is a block diagram illustrating a hardware configuration of a demand management type transportation service system according to an embodiment.

FIG. 2 is a block diagram illustrating a hardware configuration of each of server devices of the demand management type transportation service system according to the embodiment.

FIG. 3 is a block diagram illustrating a hardware configuration of each of terminal devices of the demand management type transportation service system according to the embodiment.

FIG. 4 is an ER diagram illustrating a resident database in a passenger information management server.

FIG. 5 is a table illustrating a schema of a resident parameter.

FIG. 6 is an ER diagram illustrating a bus database in a bus operation management server.

FIG. 7 is a table illustrating a schema of a bus driving log 13-45.

FIG. 8 is an ER diagram of an aggregate database in an operation plan server.

FIG. 9 is a table illustrating a schema of an area-specific aggregate result.

FIG. 10 is a diagram illustrating an example of an overall service area to which the demand management type transportation service system according to the embodiment is applied.

FIG. 11 is a schematic route map illustrating a state of a change in operation plan on line in the demand management type transportation service system according to the embodiment.

FIG. 12 is a diagram illustrating a screen example of a passenger information terminal when the operation plan is changed.

FIG. 13 is a sequence diagram illustrating a request process in the demand management type transportation service system according to the embodiment.

FIG. 14 is a sequence diagram illustrating a process in which the demand management type transportation service system acquires a reply of a questionnaire from a passenger.

FIG. 15 is a diagram illustrating a screen example of a GUI displaying an aggregate result of dissatisfaction.

FIG. 16 is a diagram illustrating a screen example of a GUI displaying an area-specific aggregate result of dissatisfaction of each of areas.

FIG. 17 is a sequence diagram illustrating a process of making a bus operation plan.

### DESCRIPTION OF EMBODIMENTS

In the embodiment, a bus will be described as an example of a transport resource that operates to transport a passenger. A system according to the embodiment provides a service of operating a bus to transport a passenger. In the service, a user that may be a passenger can request a change in the operation of the bus. The bus is an example of the transport resource and is not limited thereto. The transport resource according to the example may be another land transportation means, water transportation means, or air transportation means.

Hereinafter, the embodiment will be described with reference to the drawings.

The embodiment described below does not limit the present invention. All the elements described in the embodiments and combinations thereof are not necessarily indispensable for the present invention.

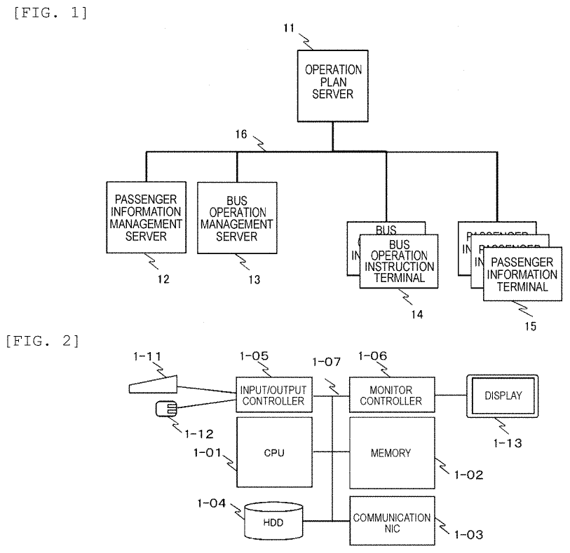

FIG. 1 is a block diagram illustrating a hardware configuration of a demand management type transportation service system according to the embodiment.

In FIG. 1, the demand management type transportation service system includes an operation plan server 11, a passenger information management server 12, a bus operation management server 13, and a bus operation instruction terminal 14. The bus operation instruction terminal 14 is an information processing terminal that is mounted on a bus vehicle such that a driver can operate the bus operation instruction terminal 14 or that is carried by the driver of the bus. The bus operation instruction terminal 14 displays information for instructing the driver to operate the bus.

A passenger information terminal 15 is a terminal that is carried by a passenger who uses the bus, and may be a mobile terminal such as a smartphone belonging to the passenger.

The operation plan server 11 is connected to the passenger information management server 12, the bus operation management server 13, the bus operation instruction terminal 14, and the passenger information terminal 15 to each other via a network 16.

An aspect of the network 16 is, for example, a case where the passenger information management server 12 and the bus operation management server 13 are connected to each other via a wired network and the bus operation instruction terminal 14 and the passenger information terminal 15 are connected to each other via a wireless network. However, there is no particular limitation on which portion of the network 16 is a wired network or a wireless network.

FIG. 2 is a block diagram illustrating a hardware configuration of each of server devices of the demand management type transportation service system according to the embodiment. The operation plan server 11, the passenger information management server 12, and the bus operation management server 13 are information processing apparatuses that share a basic hardware configuration, and this hardware configuration is illustrated in FIG. 2.

Referring to FIG. 2, the information processing apparatus includes a CPU 1-01, a memory 1-02, a communication network interface card (NIC) 1-03, a hard disk drive (hereinafter, referred to as “HDD”) 1-04, an input/output controller 1-05, a monitor controller 1-06, a bus 1-07, a display 1-13, a keyboard 1-11, and a mouse 1-12. The CPU 1-01, the memory 1-02, the communication NIC 1-03, the HDD 1-04, the input/output controller 1-05, and the monitor controller 1-06 are connected to the bus 1-07. The input/output controller 1-05 is connected to the keyboard 1-11 and the mouse 1-12. The display 1-13 is connected to the monitor controller 1-06.

The CPU 1-01 implements functions of each of the servers by executing software programs in the memory 1-02.

The memory 1-02 is a device that stores the software programs for implementing the functions of the servers and various data used for the processes of the software.

The communication NIC 1-03 is a device for allowing the server to be connected to the network 16 and to transmit and receive data and the like.

The HDD 1-04 stores a database used for the process of the server. For example, the HDD 1-04 of the passenger information management server 12 stores a database where information regarding residents is accumulated. The HDD 1-04 of the bus operation management server 13 stores a database where information regarding the bus is accumulated.

The input/output controller 1-05 is a device that controls the input and output of data to and from the server via the keyboard 1-11 and the mouse 1-12.

The monitor controller 1-06 is a device that controls the display 1-13 to display a screen.

The display 1-13 is a display device that displays a screen including an image or a text to an operator.

The keyboard 1-11 and the mouse 1-12 are devices that receive an operation from the operator and output data regarding the operation to the input/output controller 1-05.

FIG. 3 is a block diagram illustrating a hardware configuration of each of terminal devices of the demand management type transportation service system according to the embodiment. The bus operation instruction terminal 14 and the passenger information terminal 15 are information processing apparatuses that have basic hardware configurations similar to each other, and this hardware configuration is illustrated in FIG. 3.

The terminal device illustrated in FIG. 3 includes a touch panel 1-15 instead of the keyboard 1-11, the mouse 1-12, and the display 1-13 in the server device illustrated in FIG. 2. The passenger information terminal 15 among the terminal devices includes a global positioning system (GPS) module 1-08 and an IC reader module 1-14.

The touch panel 1-15 is a device that displays a screen to a passenger and receives an operation of the passenger on the screen.

The GPS module 1-08 is a device that receives radio waves from a GPS satellite and outputs position information of the device. The position information is used for the process as information representing a position of a passenger.

The IC reader module 1-14 is a device that reads data recorded in an IC card and outputs the read data. The data read from the IC card may be used for the process.

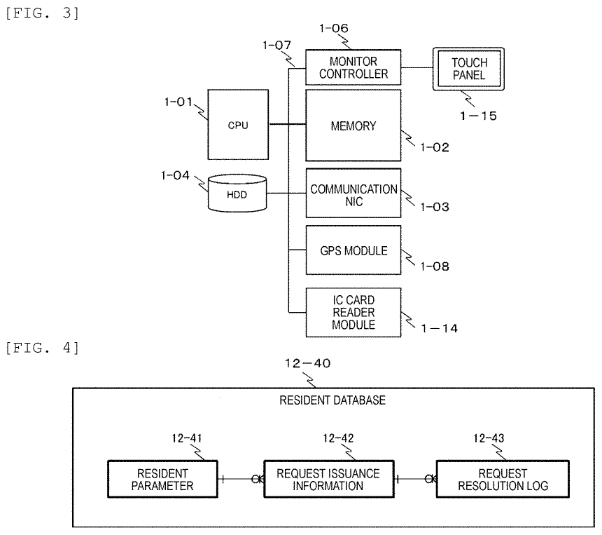

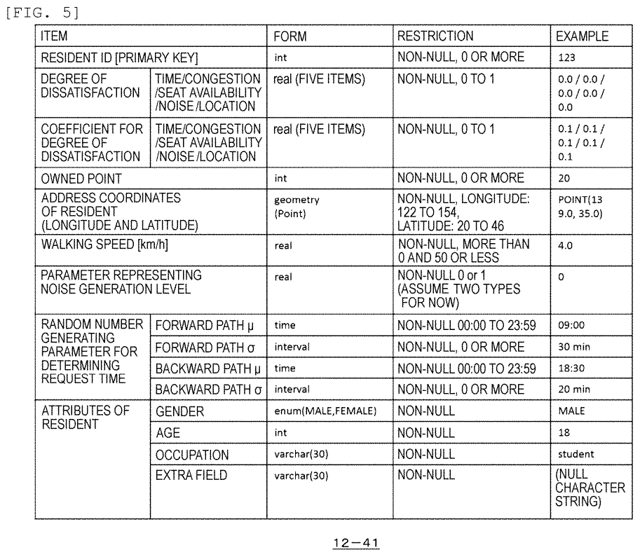

FIG. 4 is an entity relationship (ER) diagram illustrating a resident database in the passenger information management server. A resident database 12-40 is a database regarding residents in a service area where the demand management type transportation service system provides the service. It is assumed that the resident is a passenger of the bus. The resident database 12-40 includes a resident parameter table 12-41, a request issuance information table 12-42, and a request resolution log table 12-43. In the resident parameter table 21-41, various information regarding each of residents in the area that may be a passenger of the bus of the system are set. In the request issuance information table 12-42, information regarding a request issued from the resident is set. Zero or more requests correspond to one resident who is managed by the resident parameter table 12-41.

The request includes requirements requested regarding the boarding of a passenger (resident that is about to board the bus) on the bus. A request that requires a change in the operation of the bus may be present. When a request is adopted and executed, the request is resolved.

The request resolution log table 12-43 is information regarding resolution of a request issued from the resident. When a request is issued, an index (not illustrated) of the request is registered in request issuance information table 12-42. The index includes information regarding a passenger from which the request is issued, a bus where the passenger is boarding, a boarding location where the passenger gets on the bus, and a get-off location where the passenger gets off the bus.

Next, when the request is executed, the resolution of the request is recorded in a request resolution log table 12-43 as log information. The request is executed by a passenger getting on and getting off the bus. When a request that requires a change in the operation of the bus is adopted, the execution of the request accompanies the change in the operation of the bus.

Dissatisfaction of the resident for the service provided by the demand management type transportation service system is accumulated as a point. When a resident uses the bus as a passenger, the demand management type transportation service system acquires dissatisfaction of the resident for the operation of the bus by acquiring a reply of a questionnaire when the passenger gets off the bus. The point is a virtual bond that can be used for requesting to change the operation of the bus to be suitable for the request of the resident. When a request issued from a resident as a passenger of the bus is adopted, it can be expected that the degree of dissatisfaction of the resident who issues the request decreases by adopting the request. The point owned by the resident is consumed such that dissatisfaction of another resident (another passenger on the same bus) that is estimated to occur when the request is adopted is resolved. On the other hand, a point is given to the other passenger on the same bus in response to separate expression of dissatisfaction.

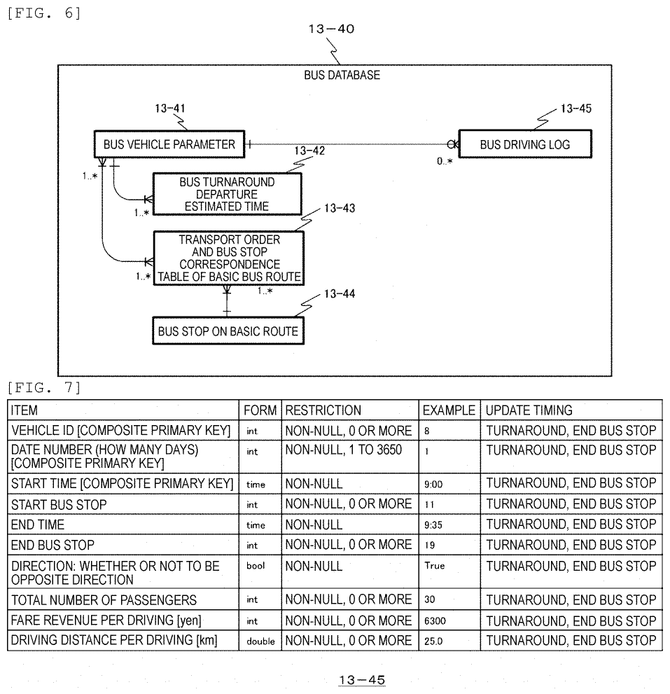

The resident parameter table 12-41 includes items including a resident ID, the degree of dissatisfaction (time/congestion/seat availability/noise/location), a coefficient for the degree of dissatisfaction (time/congestion/seat availability/noise/location), an owned point, address coordinates (longitude and latitude) of a resident, a walking speed [km/h], a parameter representing a noise generation level, random number generation parameters for determining a request time (forward path μ, forward path σ, backward path μ, backward path σ), and attributes of a resident (gender, age, occupation, others). FIG. 5 is a table illustrating a schema of the resident parameter. In each of the items of the resident parameter table 12-41, information is set according to the schema illustrated in FIG. 5.

The resident ID is identification information for identifying each of the residents.

The degree of dissatisfaction is information regarding a numerical value that represents the degree of dissatisfaction of the resident. The dissatisfaction includes dissatisfaction regarding time, dissatisfaction regarding congestion, dissatisfaction regarding seat availability, dissatisfaction regarding noise, and dissatisfaction regarding location. The dissatisfaction regarding time is dissatisfaction for the waiting time of the resident in a bus stop due to the delay of arrival of the bus. The dissatisfaction regarding congestion is dissatisfaction for congestion in the bus where the resident is boarding. The dissatisfaction regarding seat availability is dissatisfaction for the fact that no seat is available in the bus where the resident is boarding. The dissatisfaction regarding noise is dissatisfaction for noise in the bus where the resident is boarding. The dissatisfaction regarding location is dissatisfaction for the distance in which the resident walks before or after the boarding of the bus. For example, when a departure location and the boarding location are different from each other, the resident needs to walk the distance therebetween. When the get-off location and an arrival location are different from each other, the resident needs to walk therebetween.

The coefficient for the degree of dissatisfaction is a value representing the degree of importance of the resident regarding the dissatisfaction for each of the time, the congestion, the seat availability, the noise, and the location.

The owned point is information representing the point owned by the resident.

The address coordinates of the resident are information representing the address of the resident and are represented by the longitude and the latitude.

The walking speed is information representing the speed at which the resident walks and is represented by the unit km/h.

The parameter representing the noise generation level is a parameter representing the degree of an increase in the noise of the bus when the resident is boarding on the bus.

The random number generation parameter for determining the request time is a parameter for determining the time at which the request is issued. As the random number generation parameter for determining the request time, an average value μ and a standard deviation σ of the departure time of a forward path and an average value μ and a standard deviation σ of the departure time of a backward path are set.

The attributes of the resident are information representing various attributes of the resident. The attributes of the resident include gender, age, occupation, and the like.

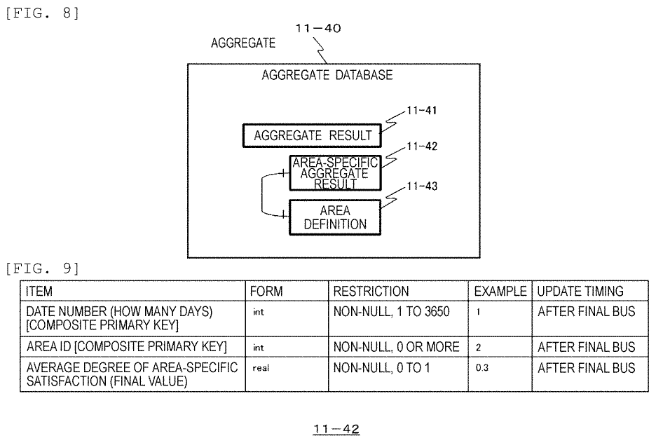

FIG. 6 is an ER diagram illustrating a bus database in the bus operation management server. A bus database 13-40 includes a bus vehicle parameter table 13-41, a bus turnaround departure estimated time table 13-42, a transport order-bus stop correspondence table 13-43 of a basic bus route, a bus stop 13-44 on the basic route, and a bus driving log 13-45.

The bus vehicle parameter table 13-41 is information regarding each bus vehicle that transports passengers as the transport resource of the system. In the bus vehicle parameter table 13-41, indices of a bus vehicle ID, a bus identifier, a basic bus route ID, a fare revenue [yen], a driving distance [km], and a coefficient for fare calculation are present, and information is described in each of the indices.

The bus turnaround departure estimated time table 13-42 is information regarding the operation of each bus vehicle from a start location. Typically, one bus vehicle is used for one or more operations. Therefore, in the bus turnaround departure estimated time table 13-42, information regarding one or more operations is recorded for one bus vehicle. In the bus turnaround departure estimated time table 13-42, indices (not illustrated) of a bus vehicle ID, a bus departure direction (for example, whether to be an opposite direction), and a departure time are present, and information is described in each of the indices.

The transport order-bus stop correspondence table 13-43 of the basic bus route is information regarding the basic route in the operation of each bus vehicle. The basic route is an estimated route on which the bus operates when a request to change the operation of the bus is not issued. Typically, a plurality of bus vehicles operate on one basic route. Typically, one bus vehicle operates on a plurality of basic routes. In the transport order-bus stop correspondence table 13-43 of the basic bus route, indices (not illustrated) of a basic bus route ID, a bus stop order number, and a bus stop ID are present, and information is described in each of the indices.

The bus stop 13-44 on the basic route is table information regarding each of bus stops on the basic route. In the table of the bus stop 13-44 on the basic route, indices (not illustrated) of a bus stop ID of each of the bus stops, a bus stop name, a GIS node ID, and a bus stop type are present, and information is described in each of the indices.

The GIS node ID is identification information for identifying each of nodes of a geographic information system (GIS). The GIS node is, for example, an intersection. The GIS node is represented by, for example, a node number, a longitude, a latitude, and geometry information.

The bus driving log 13-45 is a table of history information regarding the operation of each of bus vehicles. In the table of the bus driving log 13-45, indices (not illustrated) of a vehicle ID, a date number (how many days), a start time, a start bus stop, an end time, a last bus stop, a direction (whether to be an opposite direction), the total number of passengers, a fare revenue per driving [yen], and a driving distance per driving [km] are present, and information is described in each of the indices. FIG. 7 is a table illustrating a schema of the bus driving log 13-45. In each of the indices of the bus driving log 13-45, information is set according to the schema illustrated in FIG. 5.

FIG. 8 is an ER diagram of an aggregate database in the operation plan server. An aggregate database 11-40 includes an aggregate result 11-41, an area-specific aggregate result 11-42, and an area definition 11-43.

The aggregate result 11-41 is information where the results of the bus operation are aggregated. In the table of the aggregate result 11-41, indices of a date number (how many days), a total bus fare revenue (daily fare) [yen], and a total bus driving distance (daily distance) [km] are present, and information is described in each of the indices.

The area-specific aggregate result 11-42 is information where the results of the bus operation are aggregated for each of areas. The areas are obtained by dividing the overall service area into rectangles having a predetermined size. FIG. 9 is a table illustrating a schema of the area-specific aggregate result. In the table of the area-specific aggregate result 11-42, indices (not illustrated) of a date number (how many days), an area ID, and an average degree of area-specific satisfaction (final value) are present, and information is described in each of the indices according to the schema illustrated in FIG. 9. As the average degree of area-specific satisfaction, the total value of dissatisfaction of all the items including time, congestion, seat availability, noise, and location for each of the areas is obtained as a negative value. The average degree of area-specific satisfaction may be obtained for each of the items including time, congestion, seat availability, noise, and location and may be recorded in the aggregate result 11-42.

The area definition 11-43 is definition information of each of the areas in the overall service area. In the table of the area definition 11-43, indices (not illustrated) of an area ID and rectangle coordinates (upper left coordinate and lower right coordinate) are present, and information is described in each of the indices.

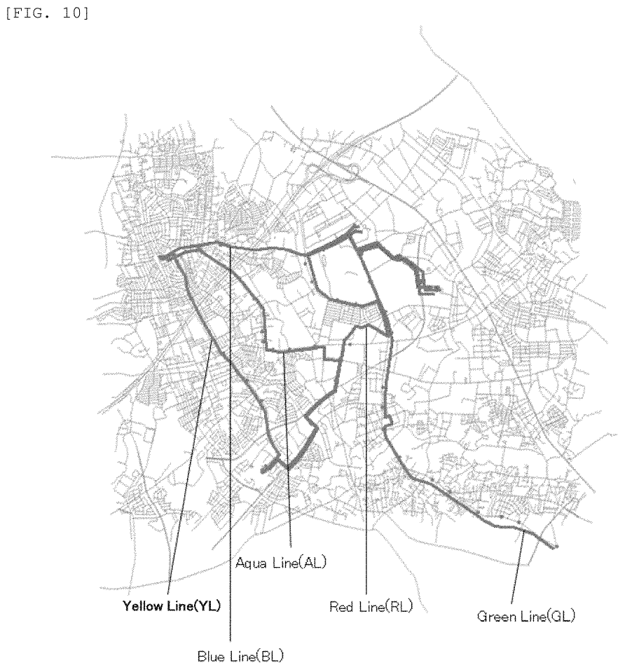

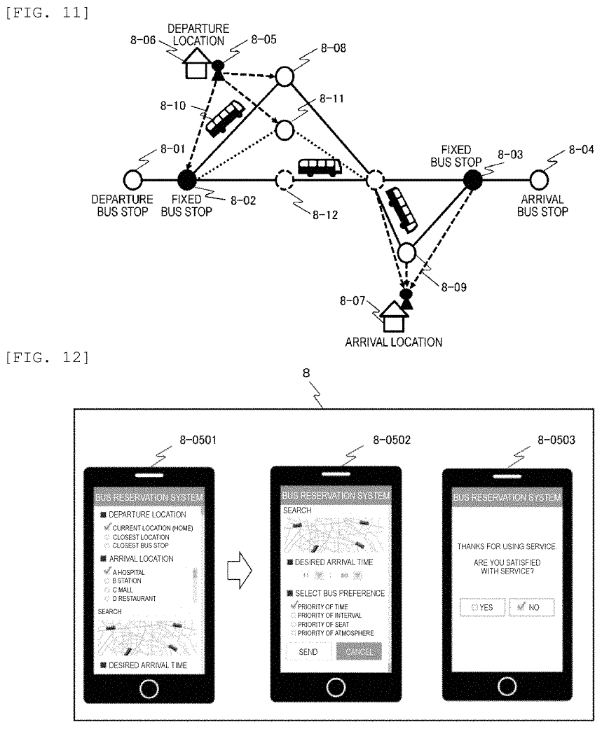

FIG. 10 is a diagram illustrating an example of the overall service area to which the demand management type transportation service system according to the embodiment is applied. For example, in the overall service area, the area is about 30 square kilometers, the population is about 120,000, and the number of users in the bus is about 4500 persons/day.

It is assumed that five regular operation bus lines are present in the overall service area. The lines are lines called Green Line (GL), Red Line (RL), Aqua Line (AL), Blue Line (BL), and Yellow Line (YL).

FIG. 11 is a schematic route map illustrating a state of a change in operation plan on line in the demand management type transportation service system according to the embodiment. FIG. 12 is a diagram illustrating a screen example of a passenger information terminal when the operation plan is changed.

A bus 8-10 illustrated in FIG. 11 is assumed to be a bus whose information is described in the bus vehicle parameter table 13-41. The bus 8-10 operates from a departure bus stop 8-01 to an arrival bus stop 8-04 as described in the transport order-bus stop correspondence table 13-43 of the basic bus route. The basic route follows the departure bus stop 8-01, a fixed bus stop 8-02, a fixed bus stop 8-03, and the arrival bus stop 8-04. The fixed bus stops 8-02 and 8-03 are assumed to be bus stops through which the bus needs to pass even when the operation plan is changed.

Here, it is assumed that a passenger 8-05 described in the resident parameter table 12-41 issues a request to board the bus using the passenger information terminal 15. The request is registered in the request issuance information table 12-42 table of the passenger information management server 12.

The passenger 8-05 can freely designate a departure location 8-06 and an arrival location 8-07 of the passenger in the request. For example, the passenger's home can be designated as the departure location, and a final destination location can be designated as the arrival location. In a screen example 8-0501 of the passenger information terminal 15 illustrated in FIG. 12, an example of designating the departure location and the arrival location is illustrated. In the screen example 8-0501, an example where the home is designated as the departure location and A hospital is designated as the arrival location. In the request, the passenger 8-05 may desire the bus to stop at a location 8-08 close to the departure location and/or may desire the bus to stop at a location 8-09 close to the arrival location.

The passenger 8-05 can also set the priority for various other desires in the request. For example, the passenger 8-05 can designate that the stopping of the bus at a desired location is preferred (priority of place) than the other items. The passenger 8-05 can designate that a reduction in the waiting time at a bus stop is preferred (priority of time) than the other items. The passenger 8-05 can designate that a bus having a sufficient empty space is preferred (priority of interval) than the other items. The passenger 8-05 can designate that seat availability is preferred (priority of seat) than the other items. The passenger 8-05 can designate that low noise level in the bus is preferred (priority of atmosphere) than the other items. In a screen example 8-0502 of FIG. 12, a screen example in which the desired arrival time and the priority of time are designated is illustrated. The screen example 8-0502 of FIG. 12 is a series screen after scrolling down the screen example 8-0501.

The request from the passenger 8-05 is processed in the demand management type transportation service system. The details of the process of the request will be described below. As a result of the process, the bus 8-10 may deviate from a predetermined basic line to stop at a location (for example, a location 8-11 in FIG. 11) close to the departure location or the arrival location to some extent, or may stop at a location 8-12 on the predetermined basic line. When the bus operates according to the request, the result of the bus operation is recorded in the request resolution log table 12-43.

When the bus 8-10 arrives at a location (for example, the location 8-09 in FIG. 11) where the passenger 8-05 gets off the bus, the demand management type transportation service system shows a questionnaire on the passenger information terminal 15 of the passenger 8-05 to acquire a reply of the passenger 8-05. When the passenger 8-05 has dissatisfaction for the use of the bus, the passenger 8-05 can express dissatisfaction using this reply. In a screen example 8-0503 of FIG. 12, an example of a screen that displays a questionnaire and urges the passenger to give a reply is illustrated. The details of the process in which the demand management type transportation service system acquires a reply of a questionnaire from a passenger will be described below.

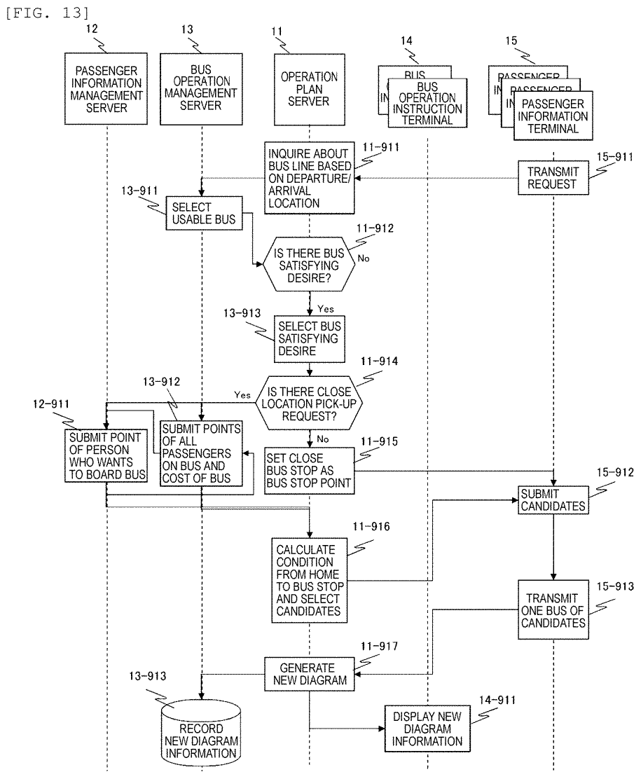

FIG. 13 is a sequence diagram illustrating a request process in the demand management type transportation service system according to the embodiment.

The passenger information terminal 15 transmits a request regarding the boarding of the bus to the operation plan server 11 (15-911). The operation plan server 11 that receives the request shows the departure location and the arrival location to the bus operation management server 13 and inquires about buses that can be used by the passenger (11-911). The bus operation management server 13 that receives the inquiry selects the usable buses based on the shown departure location and the shown arrival location (13-911) and notifies the usable bus to the operation plan server 11. Here, one or more buses are notified.

The operation plan server 11 that receives the notification of the buses that can be used by the passenger investigates whether there is a bus satisfying the desire of the passenger among the notified buses (11-912).

When there is a bus satisfying the desire of the passenger, the operation plan server 11 selects the bus (13-913).

Next, the operation plan server 11 investigates whether the request includes a request to change a bus route to a location close to the departure location or the arrival location (hereinafter, referred to as “close location pick-up request”) (11-914). When there is no close location pick-up request, the operation plan server 11 sets a bus stop close to the departure location as a bus stop where the passenger gets on the bus, sets a bus stop close to the arrival location as a bus stop where the passenger gets off the bus, sets the bus stops as bus stop points (11-915). One or more bus candidates that can be used by the passenger are notified to the passenger information terminal 15 together with the bus stop points. The passenger information terminal 15 displays information regarding the notified buses as candidates that can be used by the passenger (15-912).

In Step 11-914, when there is the close location pick-up request, that is, there is a request to change the route, the bus operation management server 13 requests, from the bus operation management server 13, information regarding possible dissatisfaction of a passenger previously boarding on the bus that can be used by the passenger who issues the request and information regarding a cost that is taken by changing the operation of the bus. When the operation of the bus is changed, if the arrival time of the bus at the get-off location of the passenger is delayed, the passenger boarding on the bus may have dissatisfaction. The bus operation management server 13 requests, from the passenger information management server 123, information regarding a point owned by the passenger who issues the request.

The bus operation management server 13 grasps passengers boarding on the bus, and the passenger information management server 12 grasps dissatisfaction degree coefficients of all the residents. The bus operation management server 13 acquires information regarding dissatisfaction degree coefficients of all the passengers boarding on the bus in cooperation with the passenger information management server 12 and calculates the total value of dissatisfaction of all the passengers based on the dissatisfaction degree coefficients. For example, the bus operation management server 13 may calculate the total value of dissatisfaction when all the passengers of the bus express dissatisfaction at the time of changing the operation of the bus. The bus operation management server 13 calculates a cost that is taken by changing the operation of the bus. The bus operation management server 13 notifies information regarding the calculated total value of dissatisfaction and information regarding the calculated cost to the operation plan server 11 (13-912).

The passenger information management server 12 grasps the points owned by all the residents. Therefore, the passenger information management server 12 notifies information regarding the point owned by the passenger who issues the request to the operation plan server 11 (12-911).

Here, the description of the request process using FIG. 13 is temporarily stopped, and “dissatisfaction” and “point” in the system will be described.

“Dissatisfaction” according to the embodiment is dissatisfaction for the operation or the boarding of the bus. As described above, the dissatisfaction includes dissatisfaction for five items including dissatisfaction regarding time, dissatisfaction regarding congestion, dissatisfaction regarding seat availability, dissatisfaction regarding noise, and dissatisfaction regarding location. The dissatisfaction for the operation or boarding of the bus refers to the sum of the dissatisfaction for the five items. In the embodiment, the dissatisfaction for time, congestion, seat availability, noise, and location and the dissatisfaction for the operation or boarding of the bus that is the sum of the above-described dissatisfaction can be expressed or calculated by a numerical value.

“Dissatisfaction” is the sum of the products of two elements including “dissatisfaction variable” and “dissatisfaction degree coefficient” for past 30 days. “Dissatisfaction degree coefficient” is a coefficient for “dissatisfaction variable”, and the value thereof varies depending on the preference of the passenger. However, when “dissatisfaction degree coefficient” does not vary for 30 days, the passenger information management server 12 initializes “dissatisfaction degree coefficient” to a predetermined given value.

In behavioral psychology, it is known that “dissatisfaction” does not continue for a long period of time but is continuously accumulated by being repeated for short period of time. In an example of an operation of a railway that is a similar event, it is experimentally estimated that the dissatisfaction of the passenger is forgotten after about two weeks. Regarding 30 days described above, for example, a period that is about two times two weeks is set considering a margin.

On the other hand, “point” in the embodiment is a virtual bond that is given from the bus company in compensation for “dissatisfaction”. “Point” is not lost over time unlike the above-described “dissatisfaction”.

The demand management type transportation service system uses “point” owned by the passenger who issues the request as a material for determining whether the desire shown by the request can be implemented. When the desire is implemented, the demand management type transportation service system deducts or retrieves “point” according to the implemented desire.

As such, “point” is used as a medium that adjusts opposed interests between passengers. As a result of using “point”, “dissatisfaction” of the passenger may also be dissolved.

Next, the calculation of the dissatisfaction according to the embodiment will be described.

The dissatisfaction according to the embodiment is calculated from the following Expression (1).

Dis=Pt·T+Pi·I+Pa·S+Pa·A+Pl·L (1)

In Expression (1), Dis represents the dissatisfaction of the passenger. The dissatisfaction Dis is the sum of the products of the dissatisfaction degree coefficients and the dissatisfaction variables for the past 30 days. Regarding 30 days described above, in the example of the operation of the railway that is a similar event, a period that is about two times two weeks is set considering a margin based on the experimental rule that the dissatisfaction of the passenger is forgotten after about two weeks.

Pt is an abbreviation for priority of time and is a coefficient (dissatisfaction degree coefficient) for the dissatisfaction regarding time. When the priority of time is designated, the value of the coefficient Pt increases. T represents the dissatisfaction variable representing the time for which the passenger waits for the bus at the bus stop or the like. Pi is an abbreviation for priority of interval and is a coefficient for the dissatisfaction regarding congestion. I represents the dissatisfaction variable representing a ratio of the number of passengers actually boarding on the bus to the capacity of the bus, that is, the vehicle occupancy. As the vehicle occupancy decreases, the interval between passengers in the bus increases. When the priority of interval is designated, the value of the coefficient Pi increases. Ps is an abbreviation for priority of seat and is a coefficient for the dissatisfaction regarding seat availability. S represents the dissatisfaction variable representing whether the passenger is seated while boarding on the bus. When the priority of seat is designated, the value of the coefficient Ps increases. Pa is an abbreviation for priority of atmosphere and is a coefficient for the dissatisfaction regarding noise. A represents the dissatisfaction variable representing the noise level in the bus. When the priority of atmosphere is designated, the value of the coefficient Pa increases. Pl is an abbreviation for priority of place and is a coefficient for the dissatisfaction regarding boarding location. L represents the dissatisfaction variable representing the walking distance from the departure location to the boarding location. When the priority of place is designated, the value of the coefficient Pl increases.

Hereinafter, more specific examples of the dissatisfaction degree coefficients for time, congestion, seat availability, noise, and location will be described. The congestion that is the item of the dissatisfaction and the dissatisfaction degree coefficient corresponds to the interval in the priority. That is, the priority of interval means prioritizing low congestion. Likewise, the noise that is the item of the dissatisfaction and the dissatisfaction degree coefficient corresponds to the atmosphere in the priority.

All the dissatisfaction degree coefficients for the respective items including time, congestion, seat availability, noise, and location are 0.1 in the initial state. When the screen example 8-0502 in FIG. 12 is checked and the item to be preferred is designated, 0.1 is added to the dissatisfaction degree coefficient of the designated item. When the passenger prefers the item, the numerical value to be reflected for the dissatisfaction of the passenger regarding this item increases in consideration the fact that the passenger has higher dissatisfaction regarding the item than the dissatisfaction for the other items. It is noted that the upper limit of the dissatisfaction degree coefficient is 1.0.

Regarding the check box of the item to be preferred in the screen example 8-0502 of FIG. 12, only one check box may be checked, or a plurality of check boxes may be checked.

When a period in which any of the items is not checked in the screen example 8-0502 of FIG. 12 continues for 30 days, the dissatisfaction degree coefficients of all the items are initialized to 0.1. When any of the items is checked before 30 days are elapsed from the check of another item, the dissatisfaction degree coefficients of all the items are not initialized.

The period of 30 days described herein is exemplary, and the present invention is not limited thereto. The period used for the initialization process of the dissatisfaction degree coefficients can be freely set.

Next, specific examples of the dissatisfaction variables of the respective items including time, congestion, seat availability, noise, and location will be described.

As described above, the dissatisfaction Dis is the total value of the products of the dissatisfaction degree coefficients and the dissatisfaction variables for the past 30 days. The dissatisfaction variables T, I, S, A, and L are acquired whenever the passenger uses the bus.

The unit of the dissatisfaction variable T is time. The dissatisfaction regarding time is represented by, for example, the time for which the passenger waits due to the delay of the arrival of the bus at the bus stop where the passenger gets on the bus. Here, in a specific example, a total time can be used, the total time being obtained by adding, to this time, the time by which the arrival of the bus on which the passenger is boarding at the bus stop where the passenger gets off is delayed and the response time taken until a candidate of the bus on which the passenger can get is shown in response to a request to use the bus after the passenger issues the request.

The dissatisfaction variable I is the vehicle occupancy, and the unit obtained by normalizing percent is used. When the vehicle occupancy is 100%, the dissatisfaction variable I is set as 0, and when the vehicle occupancy is 150%, the dissatisfaction variable I is set as 1. When the vehicle occupancy is lower than 100%, the dissatisfaction variable I is set as 0. When the vehicle occupancy is 150% or higher, the dissatisfaction variable I is set as 1. When the vehicle occupancy is in a range of 100% to 150%, the dissatisfaction variable I is set as a value that changes linearly to a certain degree depending on the change in vehicle occupancy.

The dissatisfaction variable S is a value representing whether a seat is available. When a seat is available, the dissatisfaction variable S is set as 0, and when a seat is not available, the dissatisfaction variable S is set as 1.

The dissatisfaction variable A represents the noise level in the bus. For example, the dissatisfaction variable A may be obtained by providing a sound level sensor in the bus vehicle and normalizing the measured value. Alternatively, the dissatisfaction variable A may be obtained by representing situations in which to what extent the noise level in the bus vehicle increases to using numerical values and normalizing the numerical values. For example, the number of teenager passengers on the bus where the target passenger is boarding may be used. When the number of teenager passengers is 5, the dissatisfaction variable A is set as 0, When the number of teenager passengers is 10, the dissatisfaction variable A is set as 1, and when the number of teenager passengers is in a range of 5 to 10, the dissatisfaction variable A is set as a value that changes linearly to a certain degree depending on the change in number of persons. When the number of teenager passengers is less than 5, the dissatisfaction variable A is set as 0, and when the number of teenager passengers is 10 or more, the dissatisfaction variable A is set as 1.

The dissatisfaction variable L is a value representing whether the close location pick-up request is adopted. When the close location pick-up request is adopted, the dissatisfaction variable L is set as 0, and when the boarding at a bus stop on the basic route is instructed without adopting the close location pick-up request to designate a certain location, the dissatisfaction variable L is set as 1. When boarding at a location between the location designated in the close location pick-up request and the location on the bus stop on the basic line is instructed, the dissatisfaction variable L is set as a value between 0 and 1 according to the ratio between the distance between the instructed boarding location and the location designated in the close location pick-up request and the distance between the instructed boarding location and the bus stop on the basic line.

Next, “point” in the embodiment will be described.

The point in the embodiment can be calculated from the following Expression (2) or (3). Expression (2) is a calculation formula when an operator (bus company) of the demand management type transportation service system gives a point to the passenger of the bus. Expression (3) is a calculation formula when the bus company retrieves the point.

Point+=Dis (when the passenger gets off the bus) (2)

Point−=Σ(Estimated Value of Dis of Passenger in Bus) (when the route is fixed) (3)

The point of the passenger who issues a request is retrieved by the bus company as shown in Expression (3) when the operation route of the bus is fixed based on the request. When the operation route of the bus is changed by the request such that another passenger has dissatisfaction, the point given to the passenger is calculated from Expression (2).

The point is a numerical value of 0 or more and is not lost after a predetermined period unlike the above-described dissatisfaction.

“Dissatisfaction” and “Point” described above can be summarized as follows.

<1> The amounts of the dissatisfaction and the point are not the same.

<2> The point is generated based on the dissatisfaction, but the values thereof are basically independent of each other.

<3> The dissatisfaction increases by being repeated within a short period of time but disappears over time.

Here, the description will continue referring back to FIG. 13.

The operation plan server 11 extracts buses and boarding locations that can satisfy conditions capable of implementing the close location pick-up at a location between the departure location and the bus stop on the basic route, and selects candidates of the bus on which the passenger who issues the request gets (11-916).

In Step 11-915 or Step 11-916, the operation plan server 11 selects candidates of the bus on which the passenger who issues the request gets. Here, the operation plan server 11 compares the point owned by the passenger who desires boarding and issues the request to the estimated dissatisfaction (1 (the estimated values of Dis of passengers in the bus)) of all the passengers in the bus when the operation of the bus is changed based on the request. When the point owned by the passenger who issues the request is more than the estimated dissatisfaction of all the passengers in the bus, the operation plan server 11 determines that the operation of the bus can be changed based on the request and determines to execute the change through the selection of the passenger who issues the request. When the change in the operation of the bus is determined, the point is retrieved from the passenger who issues the request. Even here, irrespective of whether the operation of the bus is changed, the dissatisfaction of the passenger in the bus is calculated, and the point is given to the passenger using the above-described method.

Conversely, when the total estimated value of the dissatisfaction of all the passengers is more than the point owned by the passenger who issues the request, the change in the operation of the bus based on the request is not implemented, and the point is not retrieved from the passenger who issues the request. However, even here, irrespective of the fact that the operation of the bus is not changed, the dissatisfaction of the passenger boarding on the bus is calculated, and a point is optionally given to the passenger.

When the operation plan server 11 selects candidates of the bus on which the passenger who issues the request gets and the boarding location, requests that are estimated based on the previous request issuance and resolution history may be issued in a pseudo manner using a random number to take the estimated requests into consideration during the selection of the candidates.

The operation plan server 11 may execute not only the comparison of the point owned by the passenger who desires boarding and issues the request to the estimated dissatisfaction of all the passengers in the bus but also selection of candidates such that an additional cost taken when the operation of the bus is changed based on the request is a predetermined threshold or less. The operation plan server 11 may select a plurality of candidates as long as the candidates satisfy the condition for the point and the dissatisfaction or the condition for the additional cost.

The passenger information terminal 15 of the passenger who issues the request displays the candidates selected by the operation plan server 11 and urges the passenger to select the bus (15-912). For example, when the passenger who desires boarding and issues the request selects any one of the candidates displayed by the passenger information terminal 15, the passenger information terminal 15 notifies information regarding the selected candidates to the operation plan server 11 (15-913).

The operation plan server 11 changes the operation of the bus based on the bus candidate notified from the passenger information terminal 15 and the boarding location and updates an operation diagram of the bus accordingly (11-917). The operation plan server 11 notifies the new diagram to the bus operation management server 13 and the bus operation instruction terminal 14. The bus operation management server 13 records the new diagram notified from the operation plan server 11 in a database (13-913). The bus operation instruction terminal 14 displays the new diagram notified from the operation plan server 11 (14-911).

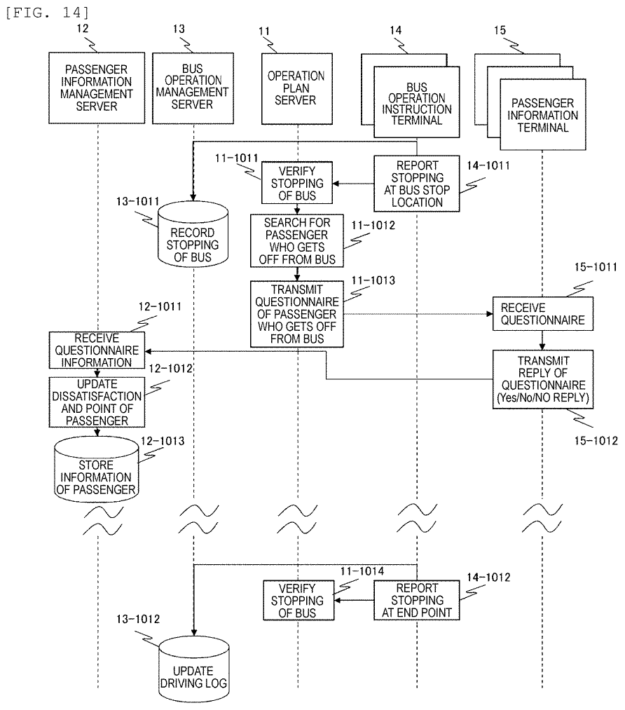

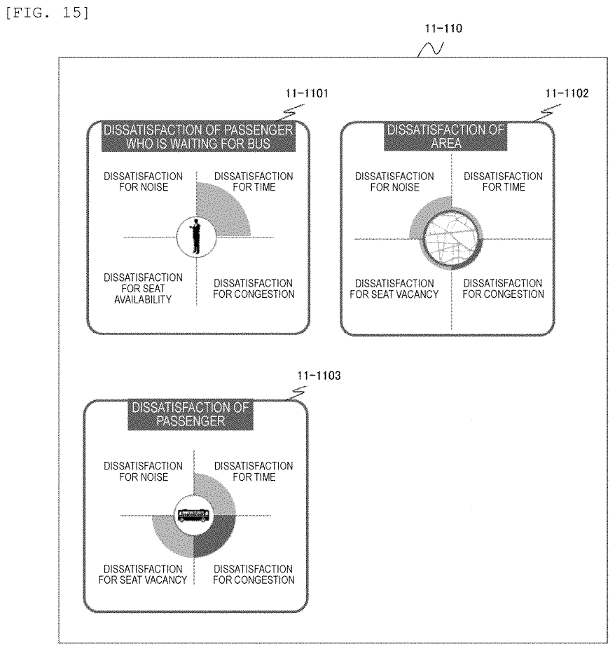

FIG. 14 is a sequence diagram illustrating the process in which the demand management type transportation service system acquires a reply of a questionnaire from the passenger. The demand management type transportation service system acquires the reply of the questionnaire when the passenger gets off the bus.

When each of the buses operates and is stopped at a bus stop location, the bus operation instruction terminal 14 of the bus reports the stopping of the bus at the bus stop location to the bus operation management server 13 and the operation plan server 11 (14-1011). The bus stop location may be a predetermined bus stop or may be a bus stop or a location other than a bus stop where the bus is to be stopped based on the request from the passenger.

When the bus operation management server 13 receives the report of stopping, the bus operation management server 13 may record the report in a driving log table 13-45 as accompanying information (13-1011).

When the operation plan server 11 receives the report of stopping, the operation plan server 11 verifies the bus to be stopped and the bus stop location based on the report (11-1011) and extracts the passenger who gets off the bus at the bus stop location from the request issuance information table 12-42 (11-1012). The operation plan server 11 transmits a questionnaire to the passenger information terminal 15 of the extracted passenger (11-1013).

The passenger information terminal 15 receives the questionnaire and displays the questionnaire on the screen (15-1011). The questionnaire in the embodiment is displayed as illustrated in a screen example 8-0503 of FIG. 12. In the embodiment, a simple questionnaire that inquires about whether the passenger is satisfied with the use of the bus is used. The passenger can reply “satisfied” or “dissatisfied” as the reply of the questionnaire or can refuse to reply. The passenger information terminal 15 transmits questionnaire information representing the reply input from the passenger for the questionnaire to the passenger information management server 12 (15-1012).

When the passenger information management server 12 receives the questionnaire information (12-1011), the passenger information management server 12 updates the value of the dissatisfaction of the passenger and the point based on the questionnaire information (12-1012). When there is dissatisfaction for the reply, the passenger information management server 12 calculates the value of the dissatisfaction from Expression (1) and adds the value of the dissatisfaction to the point from Expression (2). The passenger information management server 12 reflects the update result on the resident parameter table 12-41 (12-1013).

When the bus arrives at the last bus stop, the bus operation instruction terminal 14 of the bus reports the stopping of the bus at a last bus stop to the bus operation management server 13 and the operation plan server 11 (14-1012). Here, it is assumed that the last bus stop is not a bus stop at which the passenger gets off the bus.

When the bus operation management server 13 receives the report of stopping, the bus operation management server 13 updates the driving log table 13-45 based on the report (13-1011). When the operation plan server 11 receives the report of stopping, the operation plan server 11 verifies the bus to be stopped and the bus stop location based on the report (11-1014).

The operation plan server 11 according to the embodiment can aggregate the dissatisfaction of residents under various conditions and can display the dissatisfaction. For example, the operation plan server 11 calculates the total value of dissatisfaction of each of the areas for each of the items including time, congestion, seat availability, and noise and displays the result as a graph. As a result, the bus company easily understand the dissatisfaction of the residents including the passenger and can improve the operation of the bus and the service at the same time.

For example, the operation plan server 11 calculates the average degree of area-specific satisfaction from the following Expression (4) and calculates the total value of the dissatisfaction for each of the items and the average value of the dissatisfaction per person.

$$\begin{matrix} [ Numeral 1 ] & \\ ( \begin{matrix}Average Degree of \\ \text{Area-Specific} Satisfaction\end{matrix} ) = - \frac{1}{( \begin{matrix}Number of \\ Total Residents\end{matrix} )} {\sum }_{m ∈ λ} {\sum }_{ζ} {P}_{Z} {V}_{Z} & ( 4 )\end{matrix}$$

In Expression (4), A represents the area. P represents the dissatisfaction degree coefficient. V represents the dissatisfaction variable. Z represents the items of the dissatisfaction including time, congestion, seat availability, noise, and location. u represents the residents belonging to the area. The total number of residents is the number of the residents in the area.

In a modification example, the operation plan server 11 may acquire not only the dissatisfaction of the passenger on the bus when the passenger gets off the bus but also the dissatisfaction regarding the wait time of the passenger for the bus at the bus stop to acquire the dissatisfaction timely from the resident irrespective of whether the resident gets on the bus. The operation plan server 11 may display the dissatisfaction of the resident waiting for the bus, the dissatisfaction of the resident who does not relate to the boarding of the bus, and the dissatisfaction of the passenger on the bus as a graph.

FIG. 15 is a diagram illustrating a screen example of a graphical user interface (GUI) displaying the result where the dissatisfaction is aggregated. FIG. 15 illustrates a screen example 11-110 including a plurality of graphs 11-1101, 11-1102, and 11-1103. In each of the graphs 11-1101, 11-1102, and 11-1103 in FIG. 15, the center portion is divided into four regions from the center to the upper, lower, right and left sides, and the items including time, noise, seat availability, and congestion are assigned to the four regions. In the region of each of the items, a fan-shaped region obtained by removing a fan shape from the vicinity of the center is drawn to represent the degree of the dissatisfaction using the radius thereof.

The graph 11-1102 illustrates the total value of the dissatisfaction of the residents (including residents who is boarding on the bus and residents who is not boarding on the bus) relating to an area for each of the items. The graph 11-1101 illustrates the total value of the dissatisfaction of the passengers who use the bus for each of the items when the passengers are waiting for the bus. The graph 11-1103 illustrates the total value of the dissatisfaction of the passengers who use the bus for each of the items. Here, the example of illustrating the total value of the dissatisfaction using the graph is shown. However, the average value of the dissatisfaction per person may be illustrated using the graph.

The operation plan server 11 according to the embodiment can display the area-specific dissatisfaction of the passenger who uses the bus for each of the areas in the overall service area.

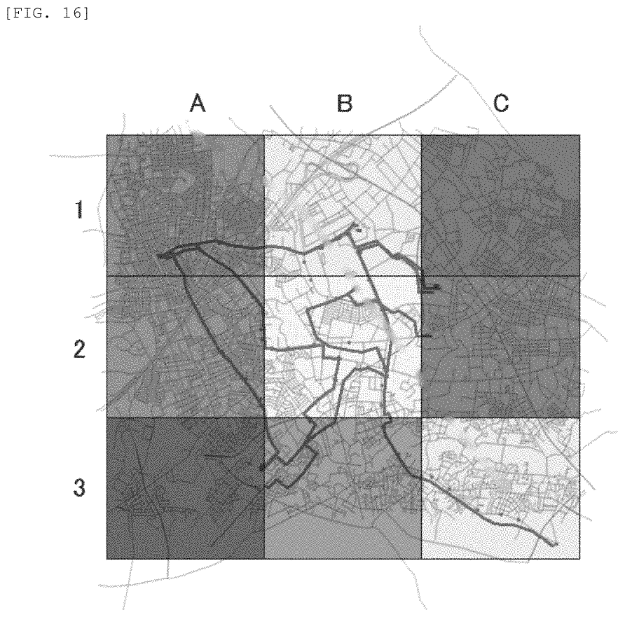

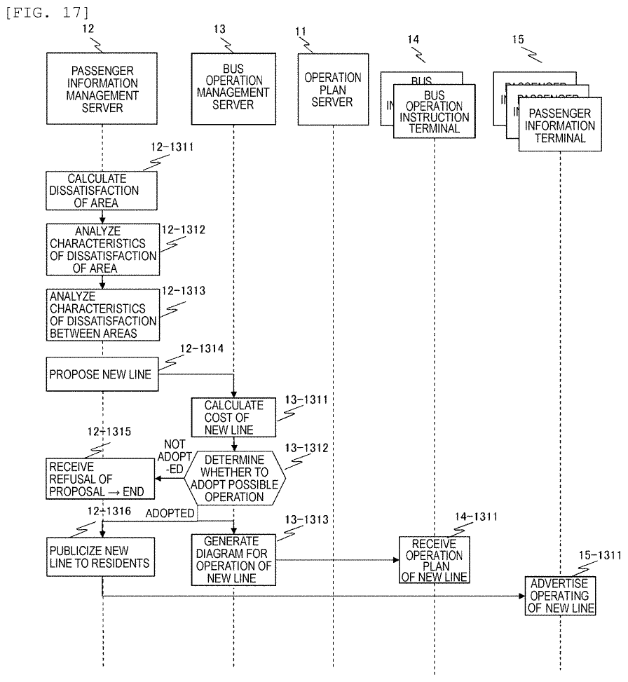

FIG. 16 is a diagram illustrating a screen example of a GUI displaying an area-specific aggregate result of dissatisfaction of each of areas. Here, it is assumed that the overall service area illustrated in FIG. 10 includes nine areas as illustrated in FIG. 16.

In FIG. 16, boundary lines that divide the overall service area into the respective areas are drawn on the map, and a screen example representing the degree of the dissatisfaction using the grey value of each of the areas is illustrated. Here, as the grey value increases, the dissatisfaction is higher.

As a method of determining whether the dissatisfaction of the passenger is the dissatisfaction of one area, for example, the dissatisfaction of the passenger who gets on the bus in the area may be assumed to be the dissatisfaction of the area. Alternatively, the dissatisfaction of the passenger who gets off the bus in the area may be assumed to be the dissatisfaction of the area.

FIG. 16 illustrates the example in which the nine areas belong to the overall service area. However, there is no upper limit in the number of areas belonging to the overall service area.

FIG. 16 illustrates the example in which the shape of each of the areas belonging to the overall service area is rectangular. However, the shape of the area is not particularly limited. The areas may have the same shape such as a rectangular shape or a hexagonal shape, or the shapes of the areas may be different from each other.

The demand management type transportation service system according to the embodiment can make a new bus operation plan based on the information regarding the dissatisfaction collected from the residents.

FIG. 17 is a sequence diagram illustrating a process of making a bus operation plan. The process may be executed as a batch process after the end of the operating hours where the bus operates.

The passenger information management server 12 calculates the dissatisfaction of each of the items in each of the areas (12-1311). Here, the passenger information management server 12 associates each of the areas and the passenger with each other based on the information regarding the boarding of the passenger on the bus acquired from the request resolution log table 12-43 illustrated in FIG. 4 such that the dissatisfaction of the passenger corresponding to the area is determined as the dissatisfaction of the area. When the location where the passenger gets on the bus is in the area, the dissatisfaction acquired when the passenger gets off the bus is determined as the dissatisfaction of the area.

The passenger information management server 12 refers to the resident parameter table 12-41 to acquire the value (degree of dissatisfaction) of the dissatisfaction of the resident and the dissatisfaction degree coefficient and calculates the sum of the values of the dissatisfaction of the passengers in each of the areas. The passenger information management server 12 divides the sum of the values of the dissatisfaction calculated for the area by the number of all the residents in the area to calculate the average value of the sums of the values of the dissatisfaction of the passengers relating to the area.

Here, the area to which the location where the passenger gets on the bus belongs is determined as the area for which the dissatisfaction of the passenger is aggregated. However, the present invention is not limited to the example. In another example, the area to which the location where the passenger gets off the bus belongs may be determined as the area for which the dissatisfaction of the passenger is aggregated. The area to which the address of the passenger belongs may be determined as the area for which the dissatisfaction of the passenger is aggregated.

Here, the bus operation plan is made based on the value of the dissatisfaction collected from the residents. However, the making of the bus operation plan does not need to be based on the value of the dissatisfaction. In another example, by using the point instead of the value of the dissatisfaction, the bus operation plan may be made based on the point owned by the resident.

Referring back to FIG. 17, the passenger information management server 12 analyzes characteristics of the dissatisfaction of each of the areas (12-1312). Specifically, the passenger information management server 12 calculates the dissatisfaction of each of the items (the type of the dissatisfaction) including time, congestion, seat availability, noise, and location in each of the areas and associates the dissatisfaction with the number of residents in the area and the attributes. A method of associating the dissatisfaction of each of the items in each of the areas with the number of residents in each of the areas and the attributes is not particularly limited. For example, the correlation may be calculated, for example, using multiple regression analysis or a Bayesian estimation method.

Next, the passenger information management server 12 analyzes characteristics of the dissatisfaction between the areas (12-1313). Specifically, the passenger information management server 12 calculates a correlation of dissatisfaction between two areas. In the example of the overall service area and the areas illustrated in FIG. 16, nine areas are present. Therefore, the number of combinations of the areas is 36, and the correlation between areas is calculated for each of the 36 combinations.

It is estimated that a common element of dissatisfaction is present in two areas having a strong correlation in dissatisfaction.

Next, the passenger information management server 12 makes a plan of a newly provided bus line based on the correlation in dissatisfaction between the areas (12-1314). Specifically, the passenger information management server 12 specifies the use of the bus having a stronger correlation among the uses of the bus of the passenger between the areas having a strong correlation. The passenger information management server 12 extracts the boarding time, the boarding location, the get-off time, and the get-off location during the use of the bus having a stronger correlation. The passenger information management server 12 estimates, as a dissatisfaction factor, lack or absence of the bus from the boarding location to the get-off location in a time zone including the boarding time and the get-off time, and proposes to newly provide a bus line where a bus operates on the route in the time zone. For example, the passenger information management server 12 estimates a bus heading from one area to a shopping mall in a time zone of 15:00 to 16:00, as a dissatisfaction factor, the passenger information management server 12 may propose, as a new line, a direct bus that operates from a representative point of the area to a shopping mall.

The passenger information management server 12 notifies information regarding the proposed new line to the bus operation management server 13.

The bus operation management server 13 calculates a cost required to operate the bus on the proposed new line (13-1311). For example, the cost may be calculated from the driving distance of the bus on the new line.

The bus operation management server 13 determines whether to adopt the new line based on the calculated cost (13-1312). For example, when the cost is equal to or less than predetermined threshold, the bus operation management server 13 may determine to adopt the new line.

When the new line cannot be adopted, the bus operation management server 13 notifies the passenger information management server 12 that the new line cannot be adopted, and the passenger information management server 12 ends the process in response to the notification (12-1315).

On the other hand, when the new line can be adopted, the bus operation management server 13 notifies the passenger information management server 12 that the new line can be adopted, and makes a bus operation diagram including the new line. The passenger information management server 12 that receives the notification that the new line can be adopted generates information for announcing the introduction of the new line to the residents, and transmits the information to the passenger information terminal 15 (12-1316). The passenger information terminal 15 that receives the information regarding the announce displays an advertisement that announces the introduction of the new line (15-1311).

The bus operation management server 13 notifies not only the made operation diagram but also the operation plan of the new line to the bus operation instruction terminal 14 (13-1313). The bus operation instruction terminal 14 that receives the notification accepts the operation plan (14-1311) and starts to instruct the operation of the bus according to the new operation diagram.

A part or the entirety of the embodiment includes the following features. It is noted that the disclosure of the embodiment is not limited to the following features.

Provided is a transport service system that provides a service of operating a transport resource (bus) to transport a user (resident or passenger), the transport service system including: a first management device (passenger information management server) that stores a first database (resident database) regarding the user and manages a request of the user; a second management device (bus operation management server) that stores a second database (bus database) regarding the transport resource and manages a status of an operation of the transport resource; and a third management device (operation plan server) that changes the operation of the transport resource in cooperation with the first management device and the second management device. The third management device acquires a numerical value representing dissatisfaction of the user, the first management device gives a point corresponding to the dissatisfaction and stores a point for each of users in the first database, the point being usable for executing a request for the operation of the transport resource, and the third management device receives a request from the user and changes a plan of the operation of the transport resource based on the request and the status of the operation of the transport resource that is managed by the second database in exchange for the point given to the user that is managed by the first database.

In the configuration, the degree of the dissatisfaction of the user is quantified, the point corresponding to the dissatisfaction is given to the user, and the request to change the operation of the transport resource is implemented in exchange for the point. Therefore, the degree of the dissatisfaction of each of the users can be reflected on the operation of the transport resource. As a result, the dissatisfaction of a plurality of users can be balanced, and the transport resource can be operated to improve the degree of satisfaction of all the users.

When the plan of the operation of the transport resource is changed, the third management device estimates dissatisfaction of another user of the transport resource and determines whether the plan of the operation of the transport resource is changeable based on the dissatisfaction of the other user and the point of the user who issues the request. In the configuration, when the operation of the transport resource is changed using the point given to the user according to the dissatisfaction, whether the request is executable is determined based on the point owned by the user and the dissatisfaction of another user caused by the change. Therefore, the dissatisfaction between the user can be balanced.

When the plan of the operation of the transport resource is changed, the third management device subtracts a point corresponding to the dissatisfaction of the other user from the point of the user who issues the request. In the configuration, when the plan of the operation of the transport resource is changed in response to the request of the user, a point corresponding to the dissatisfaction of the other user is subtracted from the point of the user who issues the request. Therefore, the operation of the transport resource can be adjusted based on the request of the user while balancing the dissatisfaction of the user.

The third management device sets, as a coefficient, a degree of importance of the user regarding each of a plurality of service quality items as targets of dissatisfaction, sets, as a variable, a measured value of an event regarding each of the service quality items, acquires a product of the coefficient and the variable for each of the service quality items, and adds up the products of the service quality items to acquire a total value, and sets the total value as a value of the dissatisfaction of the user. In the configuration, the value of the dissatisfaction of the user is calculated considering the degree of importance for each of the service quality items. Therefore, the dissatisfaction of the user for each of the items can be accurately reflected on the operation of the transport resource from multiple aspects of the service.

The third management device updates the coefficient by acquiring information regarding preference for the service quality items in response to the request from the user. Here, the preference of the user regarding the service quality items can be acquired in response to the request of the user. Therefore, time and effort required for the user to separately input the preference to reflect the degree of importance can be reduced.

When the user is transported by the transport resource, the third management device acquires whether there is dissatisfaction from the user, and when there is the dissatisfaction, the third management device causes the first management device to update the value of the dissatisfaction of the user based on the measured value of the event. Here, when the user is transported, the dissatisfaction can be acquired. Therefore, the dissatisfaction of the user can be accurately grasped and can be calculated as the degree of dissatisfaction.

The third management device extracts possible changes in the plan of the operation of the transport resource based on the dissatisfaction of the other user and the point of the user who issues the request, shows the possible changes to the user who issues the request, and executes a change selected by the user. Here, a plurality of change plans are shown to the user, and the selected change is executed. In order to satisfy the request, the user can select a more preferable change method, and the convenience of the user can be further improved.

The third management device aggregates values of the dissatisfaction in a plurality of areas divided from a service area in which the service is provided by the service and displays the aggregate result. Here, the dissatisfaction is aggregated and displayed for each of the areas. Therefore, the status of the dissatisfaction for each of the areas can be seen, and whether the transport resource is appropriately provided can be checked.

The first management device analyzes a cause of the dissatisfaction in the area based on the aggregate result and proposes the plan of the operation of the transport resource in the area to reduce the cause. Here, a cause of the dissatisfaction in each of the areas is analyzed based on the aggregate result, and the plan is proposed to reduce the cause. Therefore, the operation plan of the transport resource can be revised according to the status of the dissatisfaction of the user for each of the areas.

The service quality items include at least one of a location where the transport resource appears, a period of time required to use the transport resource, congestion in the transport resource, whether a seat is available in the transport resource, or noise in the transport resource. Here, the dissatisfaction caused during the use of the transport means is measured using the parameters including a location where the transport resource appears, a period of time required to use the transport resource, congestion in the transport resource, whether a seat is available in the transport resource, or noise in the transport resource. Therefore, the dissatisfaction of the user can be appropriately reflected on the value of the dissatisfaction.

The first management device manages the value of dissatisfaction for each of the users in the first database and sets, as a predetermined initial value, a value of dissatisfaction of a user who does not have new dissatisfaction continuously for a predetermined period of time. Here, using the calculation that is suitable for the continuity of dissatisfaction in behavioral psychology, the dissatisfaction of the user can be appropriately expressed using a numerical value.

### REFERENCE SIGNS LIST

11: operation plan server
12: passenger information management server
13: bus operation management server
14: bus operation instruction terminal
15: passenger information terminal
1-01: CPU
1-02: memory
1-03: communication NIC
1-04: hard disk drive
1-05: input/output controller
1-06: monitor controller
1-07: bus
1-08: GPS module
1-11: keyboard
1-12: mouse
1-13: display
1-14: IC card reader module
1-15: touch panel
11-40: aggregate database
11-41: aggregate result table
11-42: area-specific aggregate result table
11-43: area definition table
11-44: GIS node information table
11-45: GIS node information
12-40: resident database
12-41: resident parameter table
12-42: request issuance information table
12-43: request resolution log table
13-40: bus database
13-41: bus vehicle parameter table
13-42: bus turnaround departure estimated time table
13-43: transport order-bus stop correspondence table of basic bus route
13-44: bus stop table of basic route
13-45: bus driving log table

1. A transport service system that provides a service of operating a transport resource to transport a user, the transport service system comprising:
a first management device that stores a first database regarding the user and manages a request of the user;
a second management device that stores a second database regarding the transport resource and manages a status of an operation of the transport resource; and
a third management device that changes the operation of the transport resource in cooperation with the first management device and the second management device, wherein
the third management device acquires a numerical value representing dissatisfaction of the user,
the first management device gives a point corresponding to the dissatisfaction and stores a point for each of users in the first database, the point being usable for executing a request for the operation of the transport resource, and
the third management device receives a request from the user and changes a plan of the operation of the transport resource based on the request and the status of the operation of the transport resource that is managed by the second database in exchange for the point given to the user that is managed by the first database, wherein
when the plan of the operation of the transport resource is changed, the third management device estimates dissatisfaction of another user of the transport resource and determines whether the plan of the operation of the transport resource is changeable based on the dissatisfaction of the other user and the point of the user who issues the request.

2. (canceled)

3. The transport service system according to claim 1,
wherein
when the plan of the operation of the transport resource is changed, the third management device subtracts a point corresponding to the dissatisfaction of the other user from the point of the user who issues the request.

4. The transport service system according to claim 1, wherein
the third management device sets, as a coefficient, a degree of importance of the user regarding each of a plurality of service quality items as targets of dissatisfaction, sets, as a variable, a measured value of an event regarding each of the service quality items, acquires a product of the coefficient and the variable for each of the service quality items, and adds up the products of the service quality items to acquire a total value, and sets the total value as a value of the dissatisfaction of the user.

5. The transport service system according to claim 4, wherein
the third management device updates the coefficient by acquiring information regarding preference for the service quality items in response to the request from the user.

6. The transport service system according to claim 5, wherein
when the user is transported by the transport resource, the third management device acquires whether there is dissatisfaction from the user, and when there is the dissatisfaction, the third management device causes the first management device to update the value of the dissatisfaction of the user based on the measured value of the event.

7. The transport service system according to claim 1, wherein
the third management device extracts possible changes in the plan of the operation of the transport resource based on the dissatisfaction of the other user and the point of the user who issues the request, shows the possible changes to the user who issues the request, and executes a change selected by the user.

8. The transport service system according to claim 1, wherein
the third management device aggregates values of the dissatisfaction in a plurality of areas divided from a service area in which the service is provided and displays the aggregate result.

9. The transport service system according to claim 8, wherein
the first management device analyzes a cause of the dissatisfaction in the area based on the aggregate result and proposes the plan of the operation of the transport resource in the area to reduce the cause.

10. The transport service system according to claim 4, wherein
the service quality items include at least one of a location where the transport resource appears, a period of time required to use the transport resource, congestion in the transport resource, whether a seat is available in the transport resource, or noise in the transport resource.

11. The transport service system according to claim 1, wherein
the first management device manages the value of dissatisfaction for each of the users in the first database and sets, as a predetermined initial value, a value of dissatisfaction of a user who does not have new dissatisfaction continuously for a predetermined period of time.

12. A transport service providing method of providing a service of operating a transport resource to transport a user in a system including a first management device that stores a first database regarding the user and manages a request of the user, a second management device that stores a second database regarding the transport resource and manages a status of an operation of the transport resource, and a third management device that changes the operation of the transport resource in cooperation with the first management device and the second management device,
the transport service providing method comprising:
allowing the third management device to acquire a numerical value representing dissatisfaction of the user;
allowing the first management device to give a point corresponding to the dissatisfaction and stores a point for each of users in the first database, the point being usable for executing a request for the operation of the transport resource; and
allowing the third management device to receive a request from the user and changes a plan of the operation of the transport resource based on the request and the status of the operation of the transport resource that is managed by the second database in exchange for the point given to the user that is managed by the first database, wherein
when the plan of the operation of the transport resource is changed, the third management device estimates dissatisfaction of another user of the transport resource and determines whether the plan of the operation of the transport resource is changeable based on the dissatisfaction of the other user and the point of the user who issues the request.
